(19) United States
(12) Patent Application Publication
(10) Pub. No.: US 2015/0074014 A1
(43) Pub. Date: Mar. 12, 2015

(54) SYSTEM AND METHOD FOR AUTOMATED ROLE RE-FACTORING

(71) Applicants: John Christopher Radkowski, Los Altos Hills, CA (US); Saye Arumugam, Foster City, CA (US)

(72) Inventors: John Christopher Radkowski, Los Altos Hills, CA (US); Saye Arumugam, Foster City, CA (US)

(73) Assignee: SAP AG, WALLDORF (DE)

(21) Appl. No.: 14/025,046

(22) Filed: Sep. 12, 2013

(51) Int. Cl. G06Q 10/06

(52) U.S. Cl. CPC G06Q 10/0631
USPC 705/342

(57) ABSTRACT

In an example embodiment, roles within a job based security model are refactored to roles within a task oriented security model. The task oriented security model comprises task roles, which allow access to functionality and data, and enabler roles, which provide limits on the scope of the task roles. Data such as user assignment data, role to functionality mapping, functionality authorization objects, user identity and organizational data may be combined and normalized to create a mapping of users to functionality and organizational data. A refactoring engine may then examine the map to identify new candidate roles using contiguous regions of the map. Tuning parameters and constraints allow tuning of the candidate roles, and statistical metrics allow evaluation of the candidate roles. Candidate roles may be tested and applied in the new system.

### TECHNICAL FIELD

This disclosure relates to creating and managing secure connections between entities within separate networks. More particularly, this disclosure relates to establishing and managing secure connections between entities provided as part of a cloud service offering and entities within a private network.

### BACKGROUND

Many Enterprise Resource Planning (ERP) systems use a job based security model where users are assigned roles based on particular jobs they perform. Roles are a collection of transaction functionality associated with an authorization object. Transaction functionality includes particular functions or functionality that a user needs to access. Authorization objects provide a complex set of rules that may identify data to be accessed, access or permission level, organizational values and/or other constraints for a user attempting to access the functionality.

### BRIEF DESCRIPTION OF DRAWINGS

FIG. 1 is a diagram illustrating a multitier application environment that includes transaction functionality and authorization objects.

FIG. 2 is a diagram of a representative authorization object.

FIG. 3 is a diagram illustrating how transaction codes and authorization objects may be combined into roles and assigned to users or other entities.

FIG. 4 is a diagram illustrating role refactoring from job based roles to a set of task roles and enabler roles.

FIG. 5 is a diagram illustrating a representative role refactoring process.

FIG. 6 illustrates various systems involved in an example role refactoring process along with representative inputs and outputs.

FIG. 7 illustrates how representative inputs may be processed to create various maps that may be used in role refactoring.

FIG. 8 illustrates a representative system to take maps and refactor them into task and enabler roles.

FIG. 9 is a process diagram illustrating a representative role refactoring process.

FIG. 10 illustrates a representative role evaluation system.

FIG. 11 illustrates use of an in-memory database in one of two configurations in conjunction with the methodologies discussed herein.

FIG. 12 is a block diagram of a computer processing system, within which a set of instructions for causing the computer to perform any one or more of the methodologies discussed herein may be executed.

### DETAILED DESCRIPTION

The description that follows includes illustrative systems, methods, techniques, instruction sequences, and computing machine program products of illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

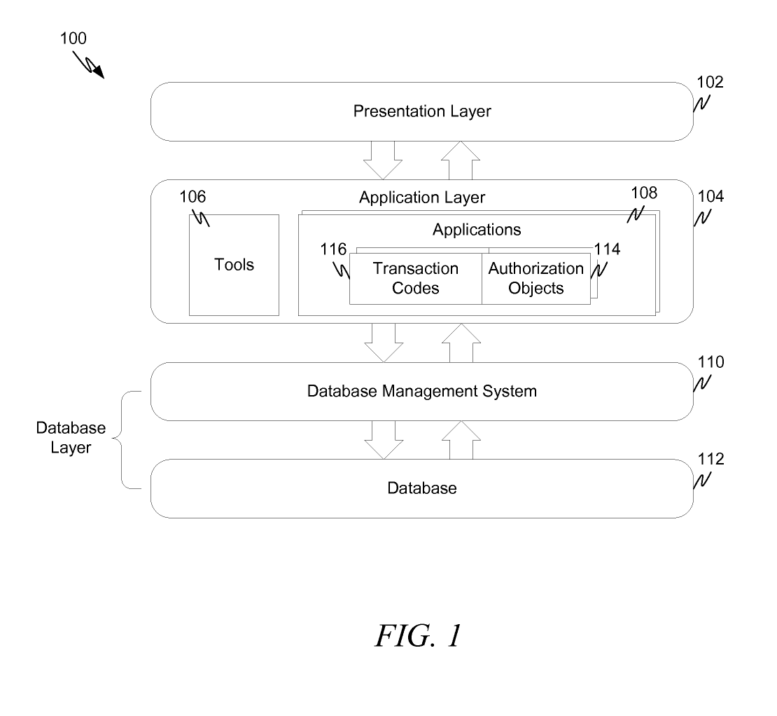

FIG. 1 is a diagram illustrating a multitier application environment that includes transaction functionality and authorization objects. The environment is shown generally as 100. Such an environment may be used, for example, in enterprise level applications. In a multitier application environment, the application functions are distributed among multiple tiers or layers in order to gain flexibility in deployment, hardware, scalability, reuse/redeployment, or other characteristics. In this disclosure, the terms “tier” and “layer” will be used interchangeably.

In this type of environment, the top layer is typically referred to as the presentation layer 102. The presentation layer 102 provides a mechanism for input, allowing users to manipulate the system, enter data, produce results, etc. The presentation layer 102 often provides a graphical user interface (GUI) on individual machines. However, the presentation layer 102 may also use servers, virtual machines, or other “backend” type machines to present a user interface via a browser or other thin client.

The application layer 104 is where business logic is executed and may include various physical or virtual machines. In the context of this disclosure, “business logic” means functionality such as various applications 108 and/or tools 106 that perform processing. Applications 108 and/or tools 106 may be any type of applications and/or tools and need not specifically be associated with a business or operation of a business, although in many instances they may be.

Applications 108 may provide functionality to a user. This functionality may be referred to as “transaction functionality.” Additionally, or alternatively, a system may provide built-in transaction functionality. In this application, transaction functionality means any particular functionality (or set of functionality) that may be accessed by a user or other entity. The functionality may be part of a transaction (in the sense that it may be fully executed or rolled back) or may be outside of a transaction. In this application, such transaction functionality may be accessed or referenced by a “transaction code,” sometimes abbreviated as “t-code.” For purposes of this application, transaction code, or t-code, may be used interchangeably with the transaction functionality itself. Transaction codes are represented in FIG. 1 by transaction codes 116.

Authorization objects may be coupled with a transaction code. In FIG. 1, authorization objects 114 are coupled with transaction codes 116. Although the plural is used, singular is also included (e.g., a transaction code may be associated with an authorization object). Authorization objects 114 provide a complex set of rules that may identify data to be accessed, access or permission level, organizational values and/or other constraints for a user attempting to access the functionality. “Organizational value” means some characteristic that describes the organization or a user's relationship to the organization. For example, organizational values may include a geographic region, a facility location, a department and/or group within the organization, a job title, a job function, a plant name, and so forth. Different organizations describe their organization and the relationship of users within the organization in different ways. These are encompassed within the definition of organizational value.

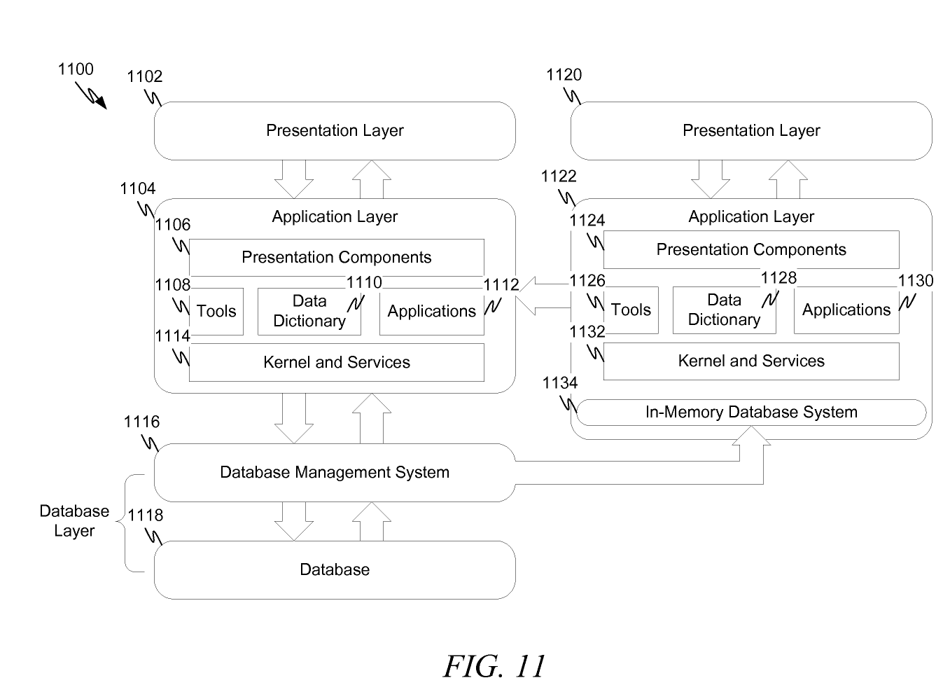

The database layer (collectively 110 and 112) holds the data needed for functioning of the application layer 104 and/or presentation layer 102. The database layer typically includes one or more database management systems 110 along with their associated database(s) 112. In many instances the database system will be a relational database system. As discussed in conjunction with FIG. 11 below, the database may be an in-memory database, or an in-memory database may be used in conjunction with a traditional disk-based database.

Mechanisms may be put in place to make the application layer 104 independent of the specific database management system 110 used in the database layer. This allows applications 108 and tools 106 to operate within various deployments/implementations without tying applications 108 and tools 106 to a specific database. The mechanisms may include a data dictionary that contains definitions and other information that can be used by system components.

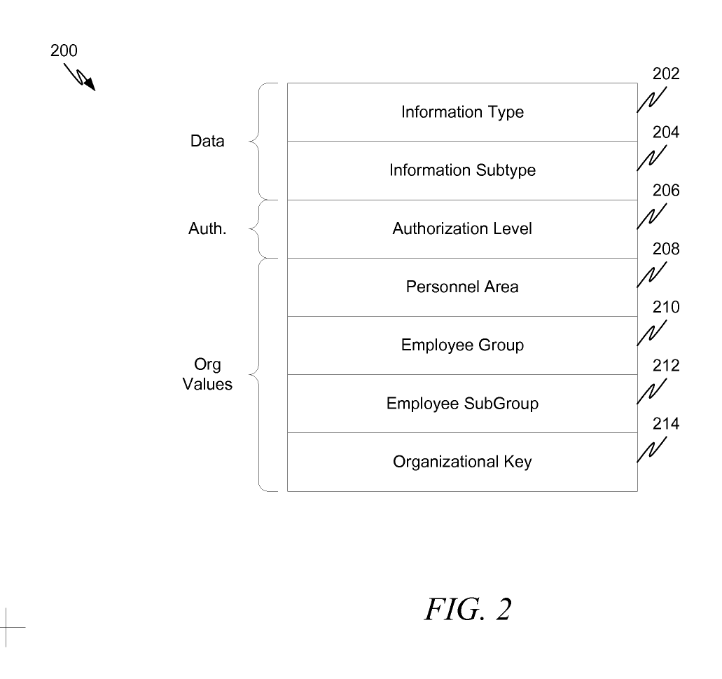

FIG. 2 is a diagram of a representative authorization object 200. Authorization objects provide a list of fields that may lead to a complex set of rules that may identify data to be accessed, access or permission level, organizational values and/or other constraints for a user attempting to access the functionality. The fields of an authorization object may be related by AND, such that access may be granted when all conditions defined by the fields are true. Authorization objects may be divided into classes if desired. An object class is a logical combination of authorization objects and may correspond, for example, to an application (financial accounting, human resources, and so on).

The representative authorization object 200 of FIG. 2 has fields that correspond to the data to be accessed, the authorization level granted, and organizational values specifying who may access the data and at what level. Thus, the representative authorization object 200 includes information type 202 and information subtype 204 which indicate that authorizations for data may be assigned at the information type and/or subtype. Authorization level 206 specifies what rights are granted (e.g., view/read, modify, create, etc.). Organizational values such as personnel area 208, employee group 210, employee subgroup 212, and organizational key 214 indicate the rights for the information type/information subtype that may be granted according to an user's personnel area, employee group, employee subgroup, and/or organizational key.

When these fields are assigned values and associated with a particular transaction code (or set of codes), access to the transaction code and associated data may be granted according to the values. If, for example, authorization object 200 is within a Human Resource (HR) object class, authorizations for personnel data within HR may be granted at the information type/subtype according to an employees personnel area, employee group, employee subgroup and organizational key.

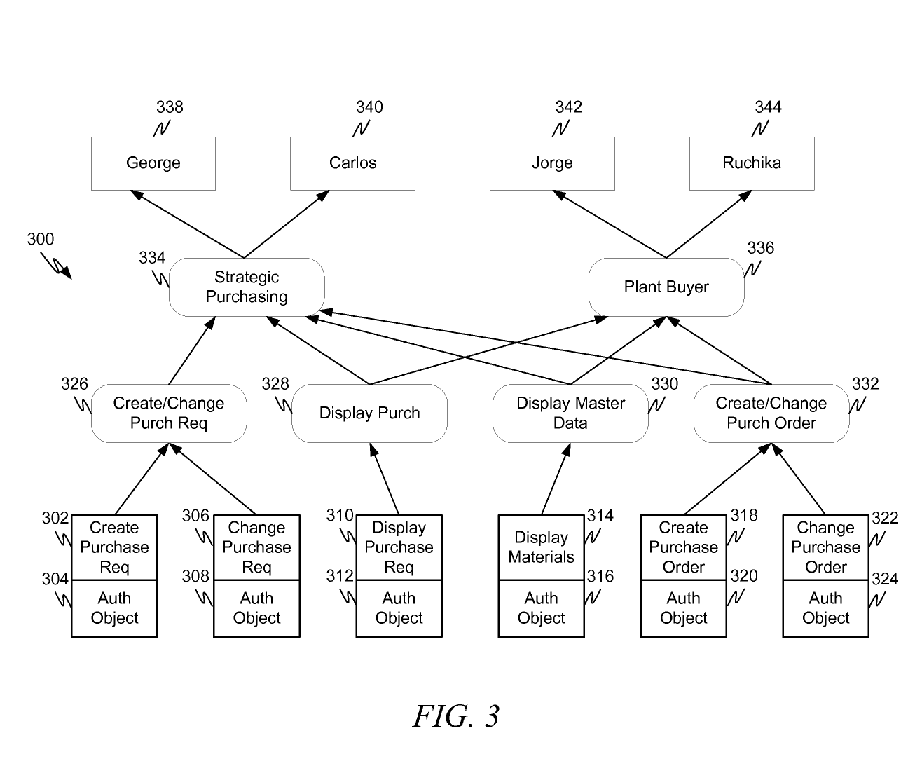

FIG. 3 is a diagram illustrating how transaction codes and authorization objects may be combined into job based roles and assigned to users or other entities. This is often used in a job based role security model. The relationship between transaction codes/authorization objects, job based roles, and users is shown generally as 300. At the bottom of the diagram, various transaction code/authorization object pairs are illustrated. These include create purchase request t-code 302 with its associated authorization object 304; change purchase request t-code 306 with its associated authorization object 308; display purchase request t-code 310 with its associated authorization object 312; display materials t-code 314 with its associated authorization object 316; create purchase order t-code 318 with its associated authorization object 320; and change purchase order t-code 322 with its associated authorization object 324.

Create purchase request t-code 302 and change purchase request t-code 306 along with their associated authorization objects 304 and 308 are combined into a role entitled create/change purchase request 326. Display purchase request t-code 310 and its associated authorization object 312 are assigned to the display purchase role 328. Display materials t-code 314 and its associated authorization object 316 are assigned to the display master data role 330. Finally, create purchase order t-code 318 and change purchase order t-code 322 along with their authorization objects 320 and 324 are combined into the create/change purchase order request role 332.

In some role based security model systems, roles can be combined into other roles, sometimes referred to as composite roles. In the example of FIG. 3, the strategic purchasing role 334 is a composite role that includes the create/change purchase request role 326, the display purchase request role 328, the display master data role 330 and the create/change purchase order role 332. The plant buyer role 336 is a composite role that includes the display purchase role 328, the display master data role 330, and the create/change purchase order role 332.

Once a structure of roles is created, they may be assigned in various combinations to various users or entities, typically based on jobs. Thus, George 338 and Carlos 340 may be assigned the strategic purchasing role 334 while Jorge 342 and Ruchika 344 may be assigned the plant buyer role 336. Job based role security gives a great deal of control over exactly how various permissions are structured and assigned to users or other entities within the organization. However, job based role security may also be very complex, with an organization having thousands upon thousands of roles in the system assigned in a variety of combinations. Thus, maintaining the roles of a job based role security model structured as illustrated in FIG. 3 may be daunting and may, in fact, create security problems since it is so difficult to manage.

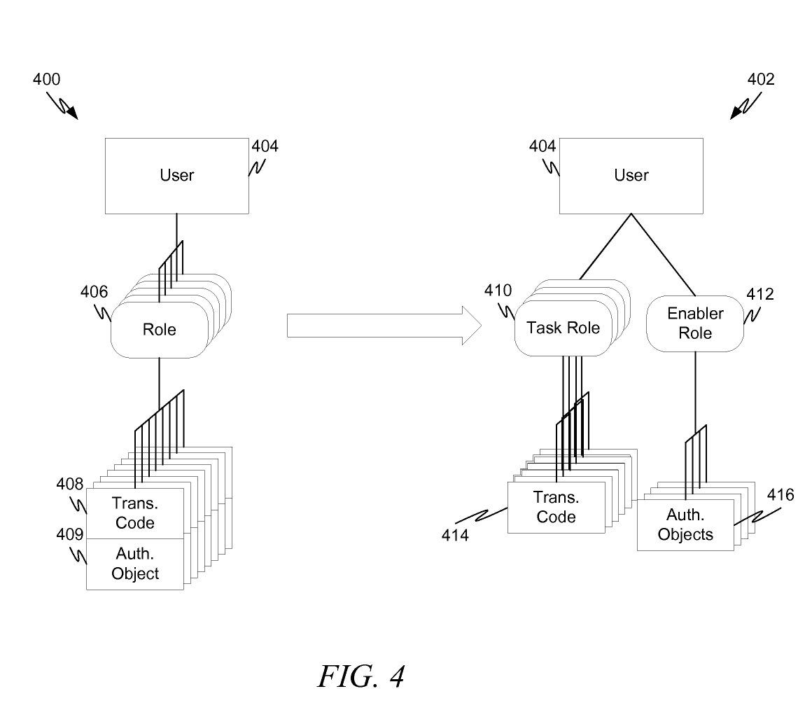

FIG. 4 is a diagram illustrating role refactoring from job based roles to a set of task roles and enabler roles. Task based roles include only the task or t-code component of a job based role. In order to provide the appropriate access, tasks are combined with enabler roles and assigned to the user. Enabler roles typically include the authorization object part of the role, based on some organizational value or set of organizational values. Separation of the organizational values from the tasks simplifies the role design and reduces the number of roles, in many instances significantly. Reductions of 90% in the number of roles are not uncommon. Task based design does result in more roles per user, but the tradeoff is in the maintenance of the roles themselves, which may be significantly simpler.

In FIG. 4, a job based role security model 400 is shown generally. A user 404 is typically assigned a number of job based roles 406. Each job based role 406 may include a number of transaction codes 408 along with their associated authorization objects 409. To refactor the roles into the task roles and enabler roles, various task roles 410 are developed, each having a number of transaction codes 414 associated with them. Task roles 410 and the associated transaction codes 414 define which transaction codes 414 a user needs to access in order to perform their job functions. Restrictions on the scope of the transaction codes 414 come in the form of enabler roles 412 which, along with their associated authorization objects 416, define the scope of data that a user is allowed to access.

As an example, suppose a user needs to be able to create a new purchase order, modify an existing purchase order, and view existing purchase orders. The scope for this particular user is that the new purchase order may only be created or an existing purchase order modified for her home geographic region. However, the user is allowed to view purchase orders not only from her home geographic region but from surrounding geographic regions as well. Thus, task roles with the appropriate t-codes may be created to give the user access to the needed functionality. Enabler roles for the home geographic region and for the surrounding geographic regions can be created. These can then be assigned to the user to give the user access to all the functionality and the appropriate scope.

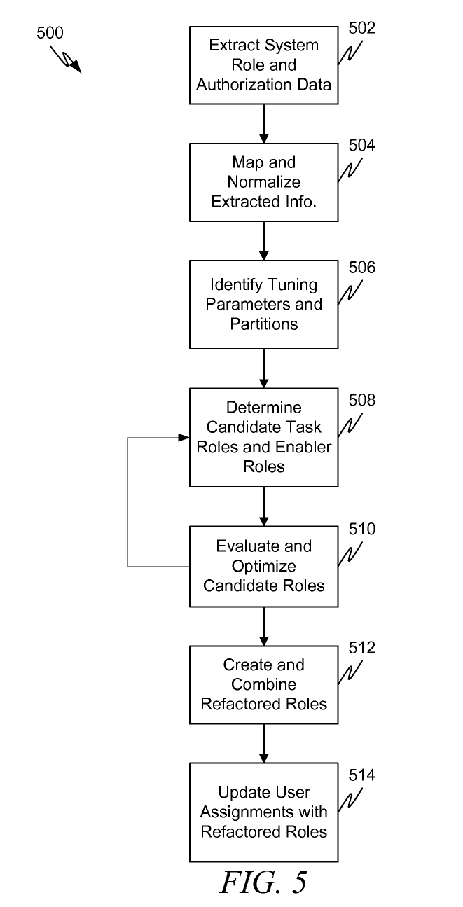

The process of moving from a job based role security model 400 to a task enabler role based model 402 may be accomplished through role refactoring. FIG. 5 is a diagram illustrating a representative role refactoring process, shown generally as 500. At operation 502 the process extracts the role and authorization information to be refactored. For example, role and authorization information may be extracted from a company's Enterprise Resource Planning (ERP) system, from various line of business applications, etc. The extracted information is the set of information to be refactored so that new refactored task and enabler roles may be created. Extracted information may include user assignment data including what organization values apply to a user such as geographic location, job title, what facility a user works in, which department a user works in, what group a user works in, etc. Extracted information may also include roles assigned to a user, a role to t-code map which includes the t-codes included in a given role, authorization objects related to t-codes, user identity and/or other organizational information such as how an organization is structured, which departments and/or groups are related to other departments and/or groups, etc.

Since the extracted information is pulled from a variety of systems, it likely exists in a variety of formats and has a variety of relationships. In operation 504 of FIG. 5, the extracted data is normalized and mapped into a common structure for processing. Examples of such mapping are discussed below, but any normalization and/or mapping may be used as long as it is sufficient to make the data accessible for further processing. Operation 504 may also include correcting data that is incorrect, eliminating data that does not further the mapping goal, and supplementing the data if desired/needed.

Operation 506 identifies the tuning parameters and partitions that will be used in the role refactoring. Tuning parameters and partitions are discussed in greater detail below. Tuning parameters and partitions influence the role refactoring process and allow a user to match the role refactoring algorithm to a particular corporate structure used in a business, a particular strategy for role refactoring, determine the correlation between the new refactored roles and the old roles, etc. In short, the tuning parameters and partitions allow the algorithm to be matched to particular role refactoring objectives.

Operation 508 illustrates the process of identifying candidate task and enabler roles. Details of this process are discussed in greater detail below. Operation 508 represents the process of refactoring the normalized information in accordance with the tuning parameters and partitions. Operation 508 produces candidate task and enabler roles, as well as identifying what task and enabler roles are assigned to what user to achieve the refactoring goals.

Operation 510 represents any evaluation of the candidate task and enabler roles that may occur, including tuning and/or optimization. If the tuning parameters include statistical measures for correlation between existing roles and candidate task and enabler roles, those statistical measures may be calculated and checked as part of operation 510 to ensure that refactoring goals are met. Potential statistical measures are discussed in greater detail below.

Once candidate task and enabler roles have been created and tested for suitability, they may be created in the system and combined as appropriate to create the task and enabler roles to be assigned to users. Operation 512 represents this process. Creating task and enabler roles typically uses system APIs or UIs to create the identified roles within the ERP and/or other systems where they will be assigned. In many instances this process may be automated. However, in some instances, automation may be supplemented by user interaction to ensure appropriate creation. In still other instances, it may be desirable for users to manually create the roles.

After task and enabler roles have been created in the system, they are assigned to users as identified in the refactoring process. Operation 514 represents this process.

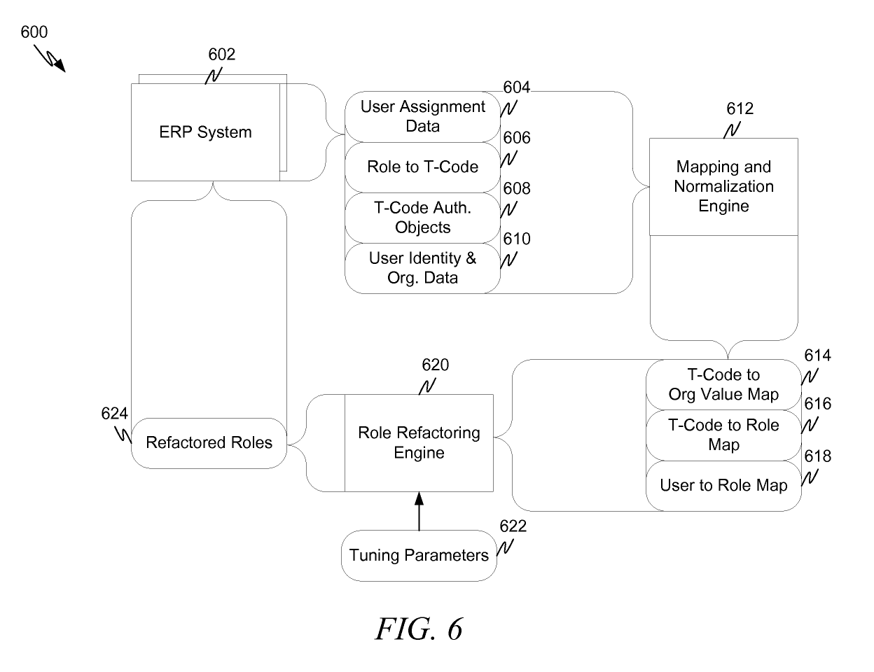

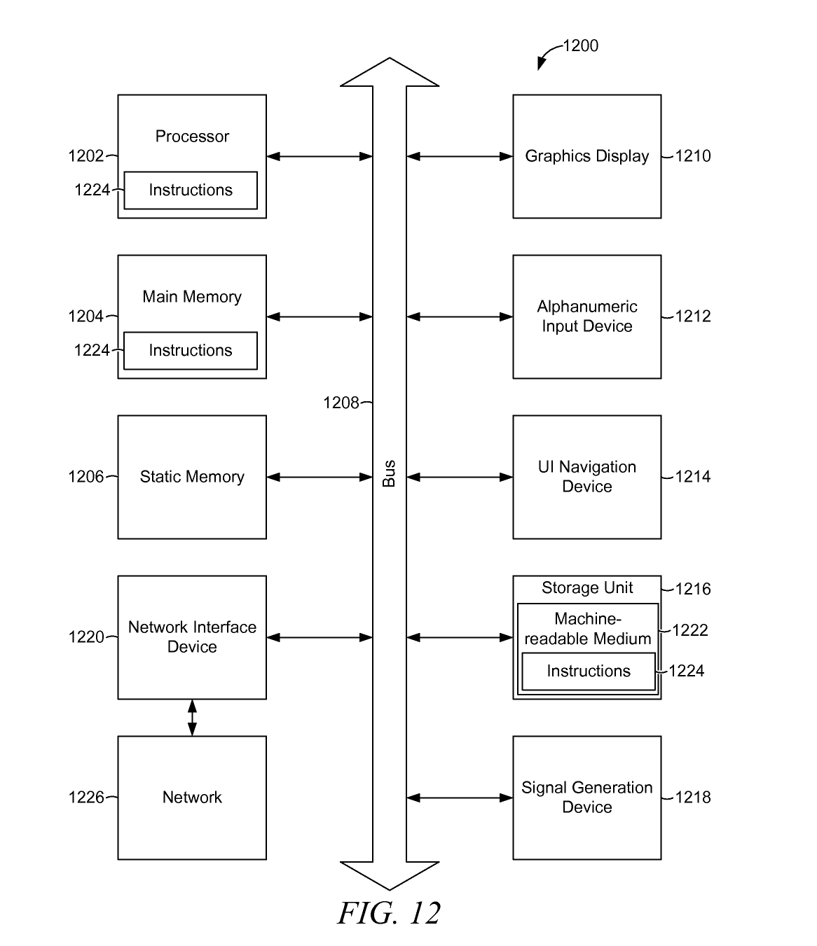

FIG. 6 illustrates various systems involved in an example role refactoring process along with representative inputs and outputs. The represented systems may be implemented using computer processing systems, including individual systems, networked systems, virtual systems, etc. as discussed in greater detail in conjunction with FIG. 12 below.

The representative systems, shown generally as 600, include ERP system(s) 602, mapping and normalization engine 612 and role refactoring engine 620. ERP systems 602 represent the sources of information that are fed into the role refactoring process. These can include ERP systems, line of business applications/systems, databases, etc. where information about the roles, with their accompanying transaction codes and authorization objects assigned to users, are stored as well as where information about organizational values are stored. As illustrated in FIG. 6, information extracted from these sources may include user assignment data 604, role to transaction code mapping 606, transaction code authorization objects 608 and user identity and organizational value data 610. User assignment data 604 is information that describes a user assigned to a role including, but not limited to, what organization values apply to a user such as geographic location, job title, what facility a user works in, which department a user works in, what group a user works in, roles assigned to a user, and so forth. Role to transaction code mapping 606 includes the transaction codes included in a given role. Transaction code authorization objects 608 include the authorization objects related to the transaction codes. User identity and organizational value data 610 includes organizational values such as how an organization is structured, which departments and/or groups are related to other departments and/or groups, and so forth.

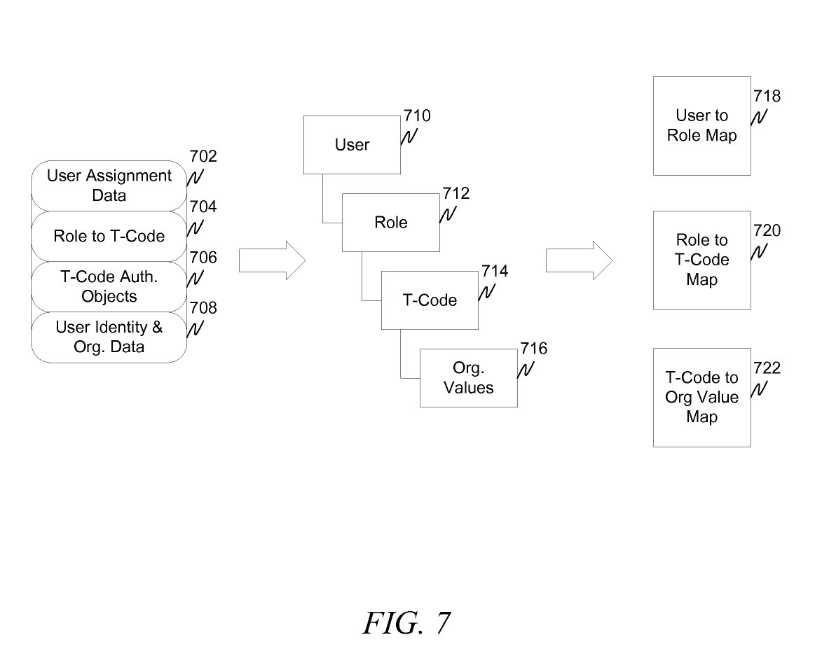

Mapping and normalization engine 612 receives the information collected from ERP system 602 and normalizes it and organizes it into a standardized format for further processing. Mapping and normalization engine 612 may be implemented in conjunction with one or more database management engines, such as those illustrated in FIG. 1 and/or FIG. 11 to take information in disparate formats, different terminology, etc. and place it into the standardized format, terminology, etc. for role refactoring. An example mapping is discussed below in conjunction with FIG. 7.

An example output of mapping and normalization engine 612 may include transaction code to organizational value map 614, transaction code to role map 616, and user to role map 618. Transaction code to organizational value map 614 includes a mapping of transaction codes to the organizational values as they exist within the extracted information. Transaction code to role map 616 includes a mapping of the roles as they exist within the extracted information and the transaction codes included within the roles. User to role map 618 includes users from the extracted information and the roles assigned to the users.

Role refactoring engine 620 takes transaction code to organizational value map 614, transaction code to role map 616 and user to role map 618 and produces refactored roles 624 in accordance with tuning parameters 622 as illustrated. The refactored roles 624 may then be assigned to users within ERP system 602.

FIG. 7 illustrates how representative inputs may be processed to create various maps that may be used in role refactoring. As discussed in FIG. 6, information describing the current roles, the current organizational values and current users are extracted from ERP systems and normalized into a common structure and various maps extracted from this common structure by a normalization and mapping engine. FIG. 7 illustrates how the extracted information may be mapped and normalized by such an engine.

In the example embodiment of FIG. 7, user assignment data 702, role to transaction code mapping 704, transaction code authorization objects 706 and user identity and organizational value information 708 represent the information extracted, for example, from the ERP system and other locations within the organization. As discussed in the example of FIG. 3, job based roles may be composite roles that include one or more other roles. Job based roles ultimately may be traced to a collection of transaction codes and associated authorization objects. Authorization objects generally include such items as data to be protected, authorization level, organizational values, and so forth as illustrated in the example of FIG. 2. Users also have associated organizational values based on job title, job function, work assignment location, and so forth. Thus, the collected information may be organized into a hierarchy where users 710 are assigned one or more job based roles 712. Job based roles 712 may include one or more transaction codes 714. Transaction codes 714 may include one or more organizational values 716.

The hierarchy of users 710, job based roles 712, transaction codes 714 and organizational values 716 may represent the normalized and organized information collected from the ERP system and/or other locations. From this hierarchy three mappings may be extracted. The first is the user to role map 718. This mapping plots users 710 on one axis and job based roles 712 on the other axis. An example user to role map is illustrated in Table 1 below. As illustrated, the mapping includes the users and their assigned roles. Table 1 illustrates only a few users and roles; however, in a typical system there may be hundreds or thousands of users and thousands of roles.

TABLE 1

| | Role 1 | Role 2 | Role 3 | Role 4 | Role 5 | Role 6 |
|---|---|---|---|---|---|---|
| User 1 | | | | | | X |
| User 2 | | | X | X | | |
| User 3 | | X | | | | |
| User 4 | | | | X | X | |
| User 5 | | X | | | | X |

The next map is the role to transaction code map 720. This map is produced by plotting roles 712 on one axis and transaction codes 714 on the other axis. An example is illustrated in Table 2 below. Although Table 2 illustrates only a few roles and transaction codes, in a real system there would be hundreds or thousands of each.

TABLE 2

| | T-Code | T-Code | T-Code | T-Code | T-Code | T-Code | T-Code |
|---|---|---|---|---|---|---|---|
| | 1 | 2 | 3 | 4 | 5 | 6 | 7 |
| Role 1 | X | | X | X | | | |
| Role 2 | | | | X | X | | |
| Role 3 | | | | | | X | |
| Role 4 | | X | | X | | | X |
| Role 5 | | X | | | | | |
| Role 6 | X | | | | | X | |

The final map is the transaction code to organizational value map 722. This map is produced by plotting transaction codes 714 on one axis and organizational values 716 on the other axis as illustrated in Table 3 example below. Although Table 3 includes only a few transaction codes and organizational values, in a real system there would be hundreds or thousands of each.

TABLE 3

| | Org Val 1 | Org Val 2 | Org Val 3 | Org Val 4 | Org Val 5 |
|---|---|---|---|---|---|
| T-Code 1 | X | | | | |
| T-Code 2 | | X | | X | |
| T-Code 3 | | | X | | |
| T-Code 4 | | | X | | |
| T-Code 5 | X | X | | | |
| T-Code 6 | | | | | X |
| T-Code 7 | | | | X | |

The user to role map 718, role to transaction code map 720 and transaction code to organizational value map 722 may be used by a role refactoring engine to produce refactored task and enabler roles.

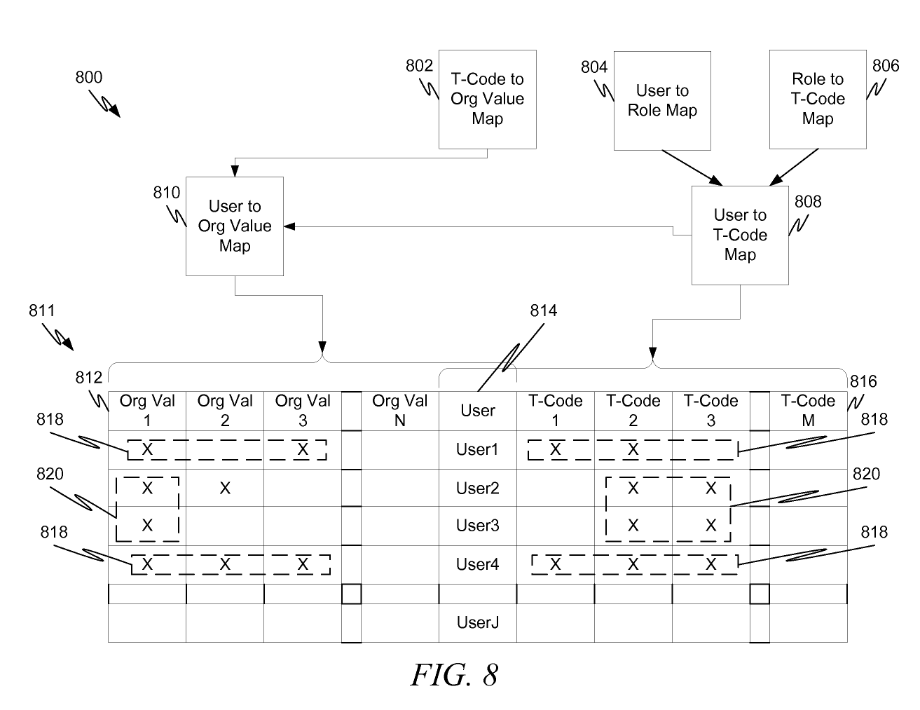

FIG. 8 illustrates a representative system to take maps and refactor them into task and enabler roles. The system, shown generally as 800, uses transaction code to organization value map 802, user to role map 804 and role to transaction code map 806 as inputs to create refactored roles. To create refactored task and enabler roles, an approach is to optimize the user—transaction code—organizational value mappings. FIG. 8 illustrates how this user—transaction code—organizational value mapping can be created.

As a first operation, the user to role map 804 and the role to transaction code map 806 can be used to create a user to transaction code map 808. This may be accomplished with matrix multiplication using Boolean operators. For example, Table 1 above is a representative user to role map and Table 2 above is a representative role to transaction code map. Replacing the “X” with ‘1’ for true (blank for false) and using Boolean operators (AND in place of multiplication, OR in place of addition), standard matrix multiplication looks gives the following.

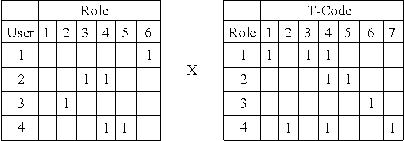

Which gives a user to transaction code mapping. The result of multiplying Table 1 and Table 2 is shown in Table 4.

TABLE 4

| | T-Code | | | | | | |
|---|---|---|---|---|---|---|---|
| User | 1 | 2 | 3 | 4 | 5 | 6 | 7 |
| 1 | 1 | | | | | 1 | |
| 2 | | 1 | | 1 | | 1 | |
| 3 | | | | 1 | 1 | | |
| 4 | | 1 | | 1 | | | |
| 5 | 1 | | | 1 | 1 | 1 | |

This mapping can be multiplied by the transaction code to organizational value mapping to give a user to organizational value map 810. Multiplying Table 3 and Table 4 gives the result in Table 5.

TABLE 5

| | Organizational Value | | | | |
|---|---|---|---|---|---|
| User | 1 | 2 | 3 | 4 | 5 |
| 1 | 1 | | | | 1 |
| 2 | | 1 | 1 | 1 | 1 |
| 3 | 1 | 1 | 1 | | |
| 4 | | 1 | 1 | 1 | |
| 5 | 1 | 1 | 1 | | 1 |

The user to transaction code mapping can be joined with the user to organizational value mapping to yield a map that includes user to transaction code mapping and user to organizational value mapping. In this example, joining Table 4 with Table 5 gives the result of Table 6.

TABLE 6

| Organizational | | | | | | | | | | | | |
|---|---|---|---|---|---|---|---|---|---|---|---|---|
| Value | | | | | | T-Code | | | | | | |
| 1 | 2 | 3 | 4 | 5 | User | 1 | 2 | 3 | 4 | 5 | 6 | 7 |
| 1 | | | | 1 | 1 | 1 | | | | | 1 | |
| | 1 | 1 | 1 | 1 | 2 | | 1 | | 1 | | 1 | |
| 1 | 1 | 1 | | | 3 | | | | 1 | 1 | | |
| | 1 | 1 | 1 | | 4 | | 1 | | 1 | | | |
| 1 | 1 | 1 | | 1 | 5 | 1 | | | 1 | 1 | 1 | |

Returning to FIG. 8, these operations are represented where user to role map 804 is multiplied by role to transaction code map 806 to give user to transaction code map 808. User to transaction code map 808 is multiplied by transaction code to organizational value map 802 to give user to organizational value map 810. User to organizational value map 810 is then joined to user to transaction code map 808 to produce the combined map shown generally as combined map 811.

Combined map 811 maps users 814 to organizational values 812 and to transaction codes 816. Combined map 811 may then be used to identify candidate task and enabler roles. Using the example in FIG. 8, user 2 and user 3 are both mapped to transaction code 2 and transaction code 3. User 2 and user 3 are also both mapped to organizational value 1. Thus, regions 820 may be created to map user 2 and user 3 to candidate task role 1 having transaction codes 2 and 3 and candidate enabler role 1 having organizational value 1. Similarly, regions 818 may be identified which map user 1 and user 4 to candidate task role 2 having transaction codes 1, 2 and 3 and candidate enabler role 2 having organizational values 1, 2 and 3.

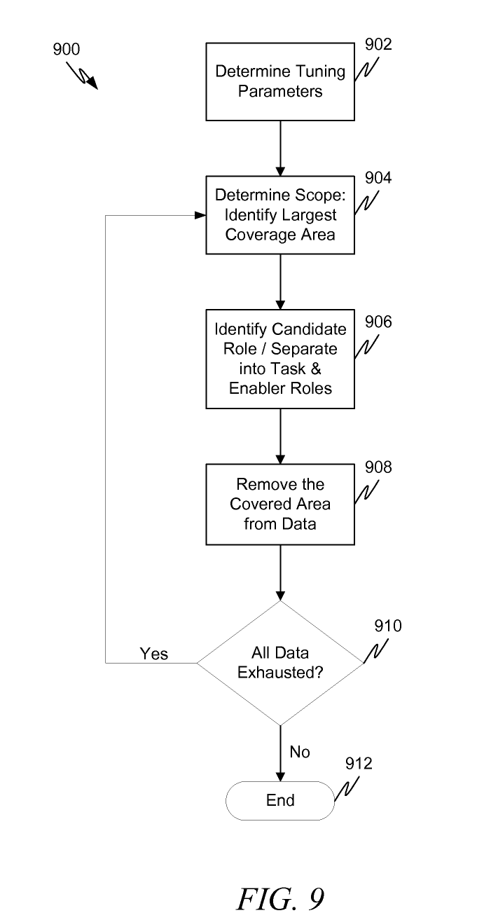

FIG. 9 is a process diagram illustrating a representative role refactoring process, shown generally as 900. The tuning parameters are acquired in operation 902. Tuning parameters influence the role refactoring process and allow a user to match the role refactoring algorithm to a particular corporate structure used in an organization, a particular strategy for role refactoring, determine the correlation between the new refactored roles and the old roles, etc. In short, the tuning parameters and partitions allow the algorithm to be matched to particular role refactoring objectives.

One set of tuning parameters may comprise scope and constraints. Scope means the selection criteria used to define the users, business processes, organizations, or other selection criteria for determining the possible roles to be refactored. Constraints are used to ensure that organization, geographic, company or other boundary conditions are applied to the candidate roles. An example may be that candidate role 1 applies to users in department A and B but not C. Thus no users from department C should be assigned to candidate role 1. Scope and/or constraint may be expressed by a set of organizational values and criteria that are applied to partition and factor roles in conjunction with the organizational values. By way of example, and not limitation, perhaps an organization would like to factor enabler roles along geographic boundaries. Thus, the joined organizational value—user—transaction code map may be filtered by organizational value(s) that describe geographic boundaries so that enabler roles will be assigned by geographic boundary. As yet another example, perhaps an organization would like to factor enabler roles by job title as well as facility location. The joined organizational value—user—transaction code map may be filtered by organizational values that describe job title and facility location so that enabler roles will be assigned by these organizational values. This filtering may also be described as a partitioning of the map.

Tuning parameters may also include statistical properties that define the resulting set of candidate roles. These statistical properties may compare various parameters between the old job based role mapping and the proposed candidate task and enabler role mappings. By way of example, such statistical measures may include those listed below.

1. Quality: a calculated value that determines the quality of the candidate role based on the number of assigned users, number of organizational values, and the coverage area (e.g., number of assigned users and number of assigned roles and/or objects). Examples of statistical metrics that can determine quality include the following.

$$Coverage Area = \# users * \# roles . \\ \% Role Efficiency = \% \frac{active permissions}{total Permissins}$$

$$\% Constraint Analysis = \% \frac{number of users with contraints}{total assigned users}$$

$$CostAnalysis = number of user changes * cost perchange$$

The above statistical values can be combined using weighted average or other methods to provide a relative quality value of the candidate role. As one example, overall quality may be calculated by:

Quality=(CoverageArea*% Role Efficiency*(1−% Constraint Analysis))/CostAnalysis

2. Consistency: a measure of the similarity of the users and/or roles proposed in the candidate role. Consistency may be measured, for example, using one of the equations below, depending on whether you are measuring the consistency of roles or permissions.

$$Consistency = \frac{total number of shared roles}{total number of shared roles assigned to each user}$$

$$Consistency = \frac{total number of permissions}{total number fo permissions assigned to each role}$$

Consistency is a measure of the role assignments by user and organizational attributes.

3. Precision: a measure of how the resulting set of roles compares with the original user to permissions assignments. Precision may be calculated based on the difference in percent between the user to permission assignment vs. the proposed candidate permission assignment.

$$Precision = \# \frac{assignment differences}{total number of assignments}$$

The statistical tuning parameters may be evaluated as candidate roles are selected, after a set of candidate roles are selected, after all candidate roles are selected, or some combination thereof.

After the tuning parameters are identified, the scope and boundary conditions are applied and the largest covered area within the map may be identified as indicated by operation 904. Various algorithms may be used to identify the largest covered area. For example, a minimum tiling algorithm such as the that described by J. Vaidya, V. Atluri, and Q. Gwo, “The Role Mining Problem: Finding a Minimum Descriptive Set of Roles,” in Proc. ACM SACMAT, pp. 175-184, 2007, incorporated herein by reference or through approximation of clique and biclique problems as described by D. S. Holchbaum, “Approximating Clique and Biclique Problems,” Journal on Algorithms, 29, pp. 174-200, 1998, incorporated herein by reference may be applied. Algorithms like that described in conjunction with FIG. 8 may also be applied which identifies largest remaining uncovered areas.

From the identified covered regions, the next set of candidate task and enabler roles may be identified as indicated by operation 906. An example was described in conjunction with FIG. 8 above. Note that the candidate task and enabler roles may be identified separately as the method proceeds, or they may be separated out after all candidate roles have been identified (e.g., after the operation 904, 906, 908 loop is complete).

Operation 908 removes the covered area used to construct the last set of candidate task and enabler roles from consideration. Test operation 910 determines whether data remains that should be factored. If so, execution proceeds from operation 904 to identify the next largest remaining area that can be covered. When the data is exhausted, the refactoring of candidate roles is complete.

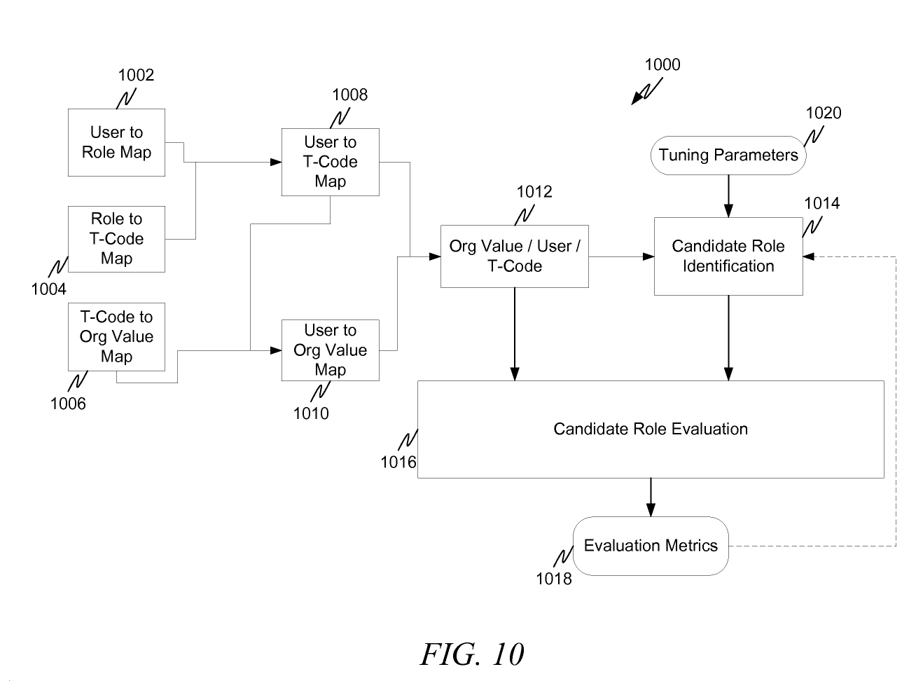

FIG. 10 illustrates a representative role evaluation system. The system, shown generally as 1000, may comprise mechanisms to create the combined organizational value—user—transaction code map 1012. As indicated, map 1012 may be created by combining the user to role map 1002 with the role to transaction code map 1004 to produce the user to transaction code map 1008. The user to transaction code map 1008 may be combined with the transaction code to organizational value map 1006 to produce user to organizational value map 1010. The user to transaction code map 1008 may then be joined to the user to organizational value map 1010 to produce the organizational value—user—transaction code map 1012.

Candidate task and enabler roles may then be identified in accordance with tuning parameters 1020 as indicated by operation 1014. Identification of candidate task and enabler roles has been previously discussed.

Candidate task and enabler roles may be evaluated for compliance with the statistical tuning metrics and/or other criteria in operation 1016. As previously discussed, such criteria may include goodness, precision, consistency and/or some combination thereof. The evaluation metrics 1018 may then be combined with the list of candidate roles. Evaluation metrics 1018 may be produced as each candidate role is identified, as a set of candidate roles are identified, after all candidate roles are identified, and/or some combination thereof. Different metrics may also be produced at different times. For example, the precision criteria may be calculated as each candidate role is identified while the consistency criteria may be calculated after all candidate roles have been identified.

The evaluation metrics 1018 and candidate roles may provide the basis for further role optimization of the candidate roles. This is indicated by the dashed line running from the evaluation metrics 1018 to the candidate role identification operation 1014.

FIG. 11 illustrates use of an in-memory database in one of two configurations (shown generally as 1100) in conjunction with the methodologies discussed herein. Since the refactoring process may deal with very large tables with thousands, tens of thousands or hundreds of thousands of entries, implementations that use database systems to handle the tables and implement the described methods may benefit from in-memory database technology. One example of a suitable in-memory database is the HANA in-memory database system available from SAP AG of Walldorf, Germany. In-memory database systems do not necessarily always maintain all data within memory at all times, but the relevant data is in memory when it needs to be and many fold improvements are seen using these systems over traditional disk based systems.

Like the HANA in-memory database system, the system of FIG. 11 illustrates two separate deployments, a side-by-side deployment where the in-memory database is deployed in conjunction with a traditional disk based database system and a stand alone deployment where the in-memory database system is deployed without a traditional disk based database system. Thus not every component illustrated in FIG. 11 may be provided for every specific embodiment.

The embodiment of FIG. 11 may represent a side-by-side deployment where an in-memory database is deployed on a side of a standard database management system. This may have several benefits, including acceleration of data read and/or writes. A side-by-side type of deployment may also allow acceleration without substantial changes in the existing deployment infrastructure or technologies. In one type of side-by-side deployment, reads and/or writes that would normally be directed to the traditional database are handled by the in-memory database instead. The in-memory database may interact with database management system 1116 and/or database 1118.

Such a side-by-side deployment may include presentation layer 1102, application layer 1104, database management system 1116, database 1118 and in-memory database system 1134, possibly deployed in either the same application layer (e.g., 1104) or a different application layer (e.g., 1122). An application layer may comprise presentation components (e.g., 1106, 1124). Presentation components may include components such as screen interpreter(s), interfaces, dialog control, etc. An application layer may also comprise kernel and services (e.g., 1114, 1132). Kernel and services may include components such as an interpreter and/or other components that implement the runtime environment. An application layer may also comprise tools (e.g., 1108, 1126) and/or applications (e.g., 1112, 1130). An application layer may also comprise a data dictionary (e.g., 1110, 1128) to provide information, data structures, definitions, etc. in a database independent format.

FIG. 11 may also illustrate a stand alone deployment where an in-memory database runs in the application layer along with any applications and/or tools. In this type of deployment, presentation layer 1120 supports application layer 1122. In-memory database system 1134 provides the database support. The other components (e.g., presentation layer 1102, application layer 1104, database management system 1116 and database 1118) do not exist in a stand alone deployment.

FIG. 12 is a block diagram of a computer processing system 1200, within which a set of instructions 1224 for causing the computer to perform any one or more of the methodologies discussed herein, may be executed.

In addition to being sold or licensed via traditional channels, embodiments may also, for example, be deployed by Software-as-a-Service (SaaS), Application Service Provider (ASP), or utility computing providers. The computer may be a server computer, a personal computer (PC), a tablet PC, a set-top box (STB), a personal digital assistant (PDA), cellular telephone, or any processing device capable of executing a set of instructions 1224 (sequential or otherwise) that specify actions to be taken by that device. Further, while only a single computer is illustrated, the term “computer” shall also be taken to include any collection of computers that individually or jointly execute a set (or multiple sets) of instructions 1224 to perform any one or more of the methodologies discussed herein.

The example computer processing system 1200 includes a processor 1202 (e.g., a central processing unit (CPU), a graphics processing unit (GPU), advanced processing unit (APU) or some combination thereof), a main memory 1204 and static memory 1206, which may communicate with each other via a bus 1208. The computer processing system 1200 may further include a graphics display 1210 (e.g., a plasma display, a liquid crystal display (LCD) or a cathode ray tube (CRT) or other display). The processing system 1200 may also include an alphanumeric input device 1212 (e.g., a keyboard), a user interface (UI) navigation device 1214 (e.g., a mouse, touch screen, or the like), a storage unit 1216, a signal generation device 1218 (e.g., a speaker), and/or a network interface device 1220.

The storage unit 1216 includes machine-readable medium 1222 on which is stored one or more sets of data structures and instructions 1224 (e.g., software) embodying or utilized by any one or more of the methodologies or functions described herein. The instructions 1224 may also reside, completely or at least partially, within the main memory 1204 and/or within the processor 1202 during execution thereof by the computer processing system 1200, with the main memory 1204 and the processor 1202 also constituting computer-readable, tangible media.

The instructions 1224 may be transmitted or received over a network 1226 via a network interface device 1220 utilizing any one of a number of well-known transfer protocols (e.g., HTTP).

While the machine-readable medium 1222 is shown in an example embodiment to be a single medium, the term “machine-readable medium” should be taken to include a single medium or multiple media (e.g., a centralized or distributed database, and/or associated caches and servers) that store the one or more sets of instructions 1224. The term “machine-readable medium” shall also be taken to include any medium that is capable of storing, encoding or carrying a set of instructions 1224 for execution by the computer and that cause the computer to perform any one or more of the methodologies of the present application, or that is capable of storing, encoding or carrying data structures utilized by or associated with such a set of instructions 1224. The term “machine-readable medium” shall accordingly be taken to include, but not be limited to, solid-state memories, and optical and magnetic media. The term “machine-readable storage medium” does not include signals or other intangible mechanisms. Such intangible media will be referred to as “machine-readable signal media.” The term “machine-readable media” will encompass both “machine-readable storage media” and “machine-readable signal media.”

While various implementations and exploitations are described, it will be understood that these embodiments are illustrative and that the scope of the claims is not limited to them. In general, techniques for maintaining consistency between data structures may be implemented with facilities consistent with any hardware system or hardware systems defined herein. Many variations, modifications, additions, and improvements are possible.

While the embodiments are described with reference to various implementations and exploitations, it will be understood that these embodiments are illustrative, and that the scope of claims provided below is not limited to the embodiments described herein. In general, the techniques described herein may be implemented with facilities consistent with any hardware system or hardware systems defined herein. Many variations, modifications, additions, and improvements are possible.

The term “computer readable medium” is used generally to refer to media embodied as non-transitory subject matter, such as main memory, secondary memory, removable storage, hard disks, flash memory, disk drive memory, CD-ROM and other forms of persistent memory. It should be noted that program storage devices, as may be used to describe storage devices containing executable computer code for operating various methods, should not be construed to cover transitory subject matter, such as carrier waves or signals. “Program storage devices” and “computer-readable medium” are terms used generally to refer to media such as main memory, secondary memory, removable storage disks, hard disk drives, and other tangible storage devices or components.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the claims. In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the claims and their equivalents.

What is claimed is:

1. A method comprising:
obtaining, using at least one processor, a map containing relationship information between a set of users, a set of transaction codes, and a set of organizational values, the relationship information identifying which transaction codes from the set of transaction codes and which organizational values from the set of organizational values are associated with each user of the set of users;
selecting, using the at least one processor, a coverage area in the map based on a scope, the coverage area comprising a transaction code and an organizational value associated with a covered user, the scope identifying a search criteria for the coverage area;
extracting, using the at least one processor, from the coverage area a candidate role comprising the transaction code associated with the covered user and the organizational value associated with the covered user; and
separating, using the at least one processor, the candidate role into a candidate task role and a candidate enabler role, the candidate task role comprising the transaction code associated with the covered user and the candidate enabler role comprising the organizational value associated with the covered user.

2. The method of claim 1, further comprising applying a set of tuning parameters that adjust the set of organizational values.

3. The method of claim 2 wherein the set of tuning parameters comprises at least one organizational value category and wherein the set of organizational values are selected in accordance with the tuning parameters.

4. The method of claim 1 further comprising calculating a set of statistical metrics comprising at least one of:
a goodness metric that measures quality of the candidate role based on a number of assigned users, a number of organizational values, and the coverage area;
a consistency metric that measures similarity of users or roles of the candidate role; and
a precision metric that compares the candidate role with original role assignments for a selected group of users.

5. The method of claim 4, wherein the set of statistical metrics act as part of a set of tuning parameters.

6. The method of claim 1, further comprising:
removing the coverage area from the map; and
performing the selecting, extracting and separating operations.

7. The method of claim 1, further comprising applying a constraint to the selected coverage area, the constraint limiting users selected as part of the coverage area.

8. A system comprising:
memory;
a computer processor coupled to the memory;
instructions stored in the memory and executable by the processor, the instructions configuring the system to:
obtain a transaction code to organizational value map relating transaction codes to organizational values, a user to role map relating users to roles, and a role to transaction code map relating roles to transaction codes;
create a map from the transaction code to organizational value map, the user to role map and the role to transaction code map, the map relating users to transaction codes and organizational values;
select a coverage area in the map, the coverage area comprising a transaction code and an organizational value associated with a covered user;
extract from the coverage area a candidate role comprising the transaction code associated with the covered user and the organizational value associated with the covered user; and
separate the candidate role into a candidate task role and a candidate enabler role, the candidate task role comprising the transaction code associated with the covered user and the candidate enabler role comprising the organizational value associated with the covered user.

9. The system of claim 8, wherein the organizational values comprise at least one of: a company; a business area; a location; a plant; a job function; a job title; a personnel area; an employee group; or an employee subgroup.

10. The system of claim 8, wherein the instructions further configure the system to: obtain a set of tuning parameters comprising at least one of:
a goodness metric that measures quality of the candidate role based on a number of assigned users, a number of organizational values, and the coverage area;
a consistency metric that measures similarity of users or roles of the candidate role;
a precision metric that compares the candidate role with original role assignments for a selected group of users;
a scope that defines search criteria for the coverage area; and
a constraint to be applied when selecting the coverage area.

11. The system of claim 10, wherein the set of instructions further configure the system to apply the set of tuning parameters when creating the map and selecting the coverage area.

12. The system of claim 8, wherein the set of instructions further configure the system to remove the coverage area and perform the selecting, extracting and separating operations.

13. The system of claim 8, wherein the set of instructions further configure the system to:
present a user interface to a user;
receive, via the user interface, user input identifying a set of tuning parameters to be applied during the selecting, extracting and separating operations; and
present, via the user interface, a set of statistical metrics to the user.

14. The system of claim 13, wherein the set of statistical metrics comprise at least one of:
a goodness metric that measures quality of the candidate role based on a number of assigned users, a number of organizational values, and the coverage area;
a consistency metric that measures similarity of users or roles of the candidate role; and
a precision metric that compares the candidate role with original role assignments for a selected group of users.

15. A machine-readable storage medium comprising instructions that, when executed by at least one processor of a machine, configure the machine to:
obtain a map relating users to transaction codes and organizational values, wherein transaction codes represent functionality users are authorized to access and wherein organizational values represent organizational characteristics related to users;
select a coverage area in the map, the coverage area comprising a transaction code and an organizational value associated with a covered user;
extract from the coverage area a candidate role comprising the transaction code associated with the covered user and the organizational value associated with the covered user; and
separate the candidate role into a candidate task role and a candidate enabler role, the candidate task role comprising the transaction code associated with the covered user and the candidate enabler role comprising the organizational value associated with the covered user.

16. The machine-readable storage medium of claim 15, wherein the instructions further configure the machine to create the map from a transaction code to organizational value map relating transaction codes to organizational values, a user to role map relating users to roles, and a role to transaction code map relating roles to transaction codes.

17. The machine-readable storage medium of claim 15, wherein the instructions further configure the machine to apply a set of tuning parameters comprising at least one of:
a set of statistical metrics to measure qualities of the candidate roles;
a search criteria to determine the coverage area; and
a constraint to apply when selecting the coverage area.

18. The machine-readable storage medium of claim 17, wherein the statistical metrics comprise at least one of:
a goodness metric that measures quality of the candidate role based on a number of assigned users, a number of organizational values, and the coverage area;
a consistency metric that measures similarity of users or roles of at least one candidate role; and
a precision metric that compares the candidate role with original role assignments for a selected group of users.

19. The machine-readable storage medium of claim 17, wherein the tuning parameters are applied when selecting the coverage area.

20. The machine-readable storage medium of claim 15, wherein the coverage area is selected based on a tiling algorithm that selects a next largest coverage area based on a search criteria, and wherein a largest coverage area is determined by a number of users multiplied by a number of assignments.
